(19) United States
(12) Patent Application Publication
(10) Pub. No.: US 2026/0210784 A1
(43) Pub. Date: Jul. 23, 2026

(54) HIGH TEMPERATURE CO-FIRED CERAMIC PRESSURE SENSOR

(71) Applicant: Bourns, Inc., Riverside, CA (US)

(72) Inventors: Kent HUTCHINGS, Logan, UT (US); Zuoyi WANG, Riverside, CA (US); Robert LIN, Riverside, CA (US); Qingqi ZHANG, III, Riverside, CA (US); Antonio GALVAN, Riverside, CA (US); Cody MORGAN, Logan, UT (US)

(21) Appl. No.: 19/447,700

(22) Filed: Jan. 13, 2026

Related U.S. Application Data
(63) Continuation of application No. PCT/US2024/037967, filed on Jul. 14, 2024.
(60) Provisional application No. 63/513,853, filed on Jul. 14, 2023.

(51) Int. Cl. G01L 9/00; G01L 19/06

(52) U.S. Cl. CPC G01L 9/0075; G01L 19/0681

(57) ABSTRACT

A pressure sensor can include a base formed from high-temperature co-fired ceramic (HTCC) material with an inner surface, a flexure plate formed from HTCC material and positioned over the surface of the base, with the flexure plate including an inner surface that faces the surface of the base and an outer surface, and a spacer having a thickness and implemented between the base and the flexure plate to define a space between the inner surfaces of the base and flexure plate. The pressure sensor can further include first and second electrodes implemented on the inner surfaces of the base and the flexure plate, respectively, to form a capacitor, such that flexing of the flexure plate due to pressure applied to the outer surface of the flexure plate results in a detectable change in capacitance of the capacitor.

### CROSS-REFERENCE TO RELATED APPLICATION(S)

This application is a continuation of International Application No. PCT/US 2024/037967 filed Jul. 14, 2024, entitled HIGH TEMPERATURE CO-FIRED CERAMIC PRESSURE SENSOR, which claims priority to U.S. Provisional Application No. 63/513,853 filed Jul. 14, 2023, entitled HIGH TEMPERATURE CO-FIRED CERAMIC PRESSURE SENSOR, the benefits of the filing dates of which are hereby claimed and the disclosures of which are hereby expressly incorporated by reference herein in their entirety.

### BACKGROUND

### Field

The present disclosure relates to high temperature co-fired ceramic pressure sensors

### Description of the Related Art

A pressure sensor can include a base portion and a deformable portion implemented relative to the base portion to thereby provide a gap therebetween and an associated capacitance. If the deformable portion moves relative to the base portion due to application of pressure, the resulting change in capacitance can be measured. Accordingly, the applied pressure can be measured from the measure capacitance.

### SUMMARY

In some implementations, the present disclosure relates to a pressure sensor that includes a base formed from high-temperature co-fired ceramic (HTCC) material and including an inner surface, a flexure plate formed from HTCC material and positioned over the surface of the base, with the flexure plate including an inner surface that faces the surface of the base and an outer surface, and a spacer having a thickness and implemented between the base and the flexure plate to define a space between the inner surfaces of the base and flexure plate. The pressure sensor further includes first and second electrodes implemented on the inner surfaces of the base and the flexure plate, respectively, to form a capacitor, such that flexing of the flexure plate due to pressure applied to the outer surface of the flexure plate results in a detectable change in capacitance of the capacitor.

In some embodiments, the HTCC material of the base can be same as the HTCC material of the flexure plate. In some embodiments, the HTCC material of the base and the flexure plate can include polymorphic phase HTCC material. In some embodiments, the polymorphic phase HTCC material can include alumina, such as at least 96% alumina.

In some embodiments, the spacer can be formed from HTCC material. In some embodiments, the base, the flexure plate and the spacer can be formed from a plurality of pieces of pre-fired HTCC and joined together to provide no discernible joint interface(s). In some embodiments, the base, the flexure plate and the spacer can be formed from separate respective pieces of pre-fired HTCC. In some embodiments, the base and the spacer can be formed from a single piece of pre-fired HTCC, and the flexure plate can be formed from another piece of pre-fired HTCC. In some embodiments, the base can be formed from a single piece of pre-fired HTCC, and the flexure plate and the spacer can be formed from another piece of pre-fired HTCC. In some embodiments, the base and a first portion of the spacer can be formed from a single piece of pre-fired HTCC, and the flexure plate and a second portion of the spacer can be formed from another piece of pre-fired HTCC.

In some embodiments, the plurality of pieces of HTCC can be joined by co-firing of the plurality of pieces of HTCC. The co-fired joint between the plurality of pieces of HTCC can include interdiffusion of elements between the HTCC pieces joined together.

In some embodiments, the spacer can be formed from an unfired HTCC on the inner surface of the base. the base and the flexure plate can be formed respective pieces of pre-fired HTCC. The base, the flexure plate and the spacer can be joined by co-firing.

In some implementations, the present disclosure relates to a method for manufacturing a pressure sensor. The method includes forming or providing a base assembly including pre-fired ceramic material and an inner surface, and forming a first electrode on the inner surface of the base assembly. The method further includes forming or providing a flexure assembly including pre-fired ceramic material, an inner surface and an outer surface and forming a second electrode on the inner surface of the flexure assembly. The method further includes co-firing the flexure assembly with the base assembly to provide a spacer having a thickness to define a space between the inner surfaces of the base assembly and the flexure assembly, and such that the first and second electrodes form a capacitor, such that flexing of the flexure assembly due to pressure applied to the outer surface of the flexure assembly results in a detectable change in capacitance of the capacitor.

In some embodiments, the pre-fired ceramic material of the flexure assembly can be formed by a high-temperature firing process, and the pre-fired ceramic material of the base assembly can be formed by a high-temperature firing process.

In some embodiments, the pre-fired ceramic material of the base assembly can be same as the pre-fired ceramic material of the flexure assembly. In some embodiments, the pre-fired ceramic material of the base assembly and the flexure assembly can include polymorphic phase high-temperature co-fired ceramic (HTCC) material. The polymorphic phase HTCC material can include alumina, such as at least 96% alumina.

In some embodiments, the spacer can be formed from high-temperature co-fired ceramic (HTCC) material. In some embodiments, the base assembly, the flexure assembly and the spacer can be formed from a plurality of pieces of pre-fired HTCC and joined together to provide no discernible joint interface(s). In some embodiments, the base assembly, the flexure assembly and the spacer can be formed from separate respective pieces of pre-fired HTCC. In some embodiments, the base assembly including the spacer can be formed from a single piece of pre-fired HTCC, and the flexure assembly can be formed from another piece of pre-fired HTCC. In some embodiments, the base assembly can be formed from a single piece of pre-fired HTCC, and the flexure assembly including the spacer can be formed from another piece of pre-fired HTCC. In some embodiments, the base assembly with a first portion of the spacer can be formed from a single piece of pre-fired HTCC, and the flexure assembly with a second portion of the spacer can be formed from another piece of pre-fired HTCC.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A shows a side sectional view of a pressure sensor 100, and FIGS. 1B and 1C show sectional views as indicated in FIG. 1A. FIGS. 2A and 2B show an example of how the pressure sensor of FIG. 1A can be utilized to measure pressure.

FIG. 3A shows a first example of a capacitive pressure sensor.

FIG. 3B shows a second example of a capacitive pressure sensor.

FIG. 3C shows a third example of a capacitive pressure sensor.

FIG. 3D shows a fourth example of a capacitive pressure sensor.

FIG. 3E shows a fifth example of a capacitive pressure sensor.

FIGS. 4A to 4C show examples related to the first, second and third examples of FIGS. 3A, 3B and 3C.

FIGS. 4D to 4G show examples related to the fourth and fifth examples of FIGS. 3D and 3E.

FIGS. 5A to 5F show further examples related to the first example of FIG. 3A.

FIGS. 6A to 6C show further examples related to the first example of FIG. 3A.

FIGS. 7A to 7D show further examples related to the first example of FIG. 3A.

FIGS. 8A and 8B show examples of capacitance-change (AC) as a function of applied pressure for two capacitive pressure sensors produced according to the examples of FIGS. 5 to 7.

FIGS. 9A to 9F show further examples related to the second example of FIG. 3B.

FIGS. 10A to 10G show further examples related to the third example of FIG. 3C.

FIGS. 11A to 11F show further examples related to the fourth example of FIG. 3D.

FIGS. 12A to 12C show further examples related to the fifth example of FIG. 3D.

### DETAILED DESCRIPTION OF SOME EMBODIMENTS

The headings provided herein, if any, are for convenience only and do not necessarily affect the scope or meaning of the claimed invention.

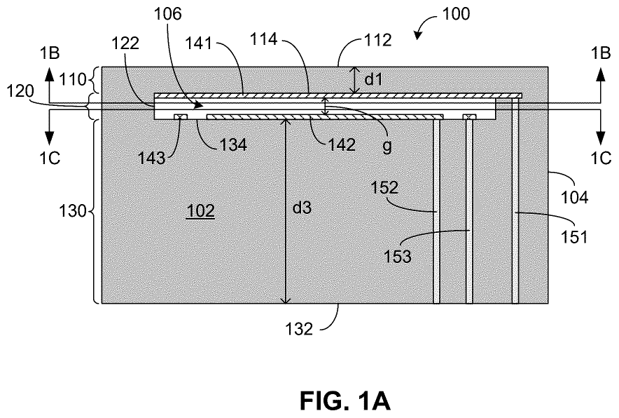

FIG. 1A shows a side sectional view of a pressure sensor 100, and FIGS. 1B and 1C show sectional views as indicated in FIG. 1A. FIGS. 2A and 2B show an example of how the pressure sensor of FIG. 1A can be utilized to measure pressure.

Referring to FIGS. 1A to 1C, a pressure sensor 100 is shown to generally include a base portion 130, a deformable portion 110, and a support portion 120 that provides support for the deformable portion 110 relative to the base portion 130 to thereby define a volume 106. Thus, the deformable portion 110 is shown to include an outer surface 112 for receiving a force associated with pressure (e.g., as in FIG. 2B), and an inner surface 114 on which is provided a first electrode 141. The base portion 130 is shown to include an outer surface 132 for mounting of the pressure sensor 100 (e.g., as in FIG. 2B), and an inner surface 134 on which is provided a second electrode 142. A guard electrode 143 can also be provided (optionally) on the inner surface 134 of the base portion. The support portion 120 is shown to include an inner surface 122 that partially defines the volume 106.

Configured in the foregoing manner, a gap dimension g is provided between the first and second electrodes 141, 142 that forms a parallel plate capacitor having a capacitance value of C≈ε(A/g), where A is the area of, for example, the second electrode 142, g is the gap dimension between the first and second electrodes 141, 142 (as shown in FIG. 1A), and ε is the permittivity of the region between the first and second electrodes 141, 142. Such a region can be part of the volume 106 filled with dielectric material such as air.

Referring to FIGS. 1A to 1C, the first electrode 141 is shown to be electrically connected to a conductive via 151, and the second electrode 142 is shown to be electrically connected to a conductive via 152. The guard electrode 143 is shown to be electrically connected to a conductive via 153; however, for the purpose of this search, such a guard electrode (143) may or may not be utilized.

In some embodiments, the base portion 130, the support portion 120 and the deformable portion 110 can be formed from same material to provide similar thermal/mechanical properties desirable during temperature changes associated with fabrication and/or operation of the pressure sensor 100. In some embodiments, such same material can be ceramic. In some embodiments, pressure sensing in high-temperature environment can be allowed by use of high-temperature co-fired ceramic (HTCC) material as the same material of the pressure sensor. As an example, HTCC can include alumina.

In some embodiments, the support portion 120 can begin as a contiguous part of one of the deformable portion 110 and the base portion 130 and be joined to the other one of the deformable portion 110 and the base portion 130 by a bond such as a diffusion bond produced by co-firing of the different portions.

In some embodiments, the support portion 120 can begin as a separate part and be joined to the deformable portion 110 and the base portion 130 by respective bonds such as diffusion bonds produced by co-firing of the different portions.

Referring to FIGS. 2A and 2B, the pressure sensor 100 of FIGS. 1A to 1C is shown to be mounted on a surface 200 to allow measurement of pressure in a region about the surface 200. In FIG. 2A, suppose that a base pressure is present in such a region. Accordingly, some base pressure will be applied to the pressure sensor 100, including a pressure on the outer surface 112 of the deformable portion 110. In such a state, the first and second electrodes 141, 142 are shown to be separated by a gap dimension of g₀, to thereby provide a respective capacitance of C₀.

In FIG. 2B, an increased pressure is shown to be applied to the pressure sensor 100, including an increased pressure (depicted as a force F) on the outer surface 112 of the deformable portion 110. In such a state, the first and second electrodes 141, 142 are shown to be separated by a decreased gap dimension of g₁, to thereby provide an increased capacitance of C₁.

Referring to FIGS. 2A and 2B, it is noted that in some applications, the capacitor cavity of the pressure sensor 100 can be in communication with an atmosphere through, for example, the vias 152, 153. Such vias can thereby act a pressure taps to the atmosphere such as an ambient atmosphere or some reference-pressure atmosphere.

It is also noted that in some applications, a vacuum can be applied to the capacitor cavity of the pressure sensor 100, and the vias 152, 153 can be sealed. Such a configuration can allow the pressure sensor 100 to measure absolute pressure values.

Referring to FIGS. 2A and 2B, it is further noted that in some applications, the pressure sensor 100 may or may not be mounted to a surface such as the depicted mounting surface 200.

In some applications, pressure measurement in harsh environments is required or desired in many industrial processes and applications. Such harsh environments can include a wide range of temperatures and pressures with rapidly fluctuating conditions. Pressure may also need to be measured in corrosive environments or combustion chambers.

For the foregoing applications, a pressure sensor typically needs to withstand these conditions without degradation or failure and also needs to be able to accurately sense pressure over a range encountered in a given application. Pressure sensors typically utilize a variety of sensing methods including piezoresistivity, strain gages, electrical capacitance, and others.

Described herein are examples related to pressure sensors that utilize parallel plate capacitance where the distance between parallel plates changes by mechanical flexure of one of the plates due to the applied pressure, as described herein in reference to FIGS. 1 and 2. As described herein, such a capacitance is inversely proportional to the distance between the parallel plates; thus, the gap between the plates and the mechanical properties of the plates are important design parameters.

Capacitive sensors can be made from many materials and many geometric designs that are based on the conditions (e.g., temperature range, pressure range, and environment) of a given application. In some embodiments, alumina can be chosen as a flexible membrane material for a pressure sensor due to its ability to withstand high temperatures, high electrical resistance, chemical inertness and good mechanical properties.

To create a parallel plate structure, two halves can be fabricated, respective electrodes can be formed on such two halves, and the two assemblies can be joined together. In some embodiments, joining of alumina based devices can be implemented using brazes, glasses, and ceramic-glass mixtures commonly used in low temperature co-fired ceramics (LTCCs). It is noted that the temperature that a given sensor will be subjected to often dictates the material used to join the two halves. However, joining of dissimilar materials or using a second material to join the two halves can result in stress in the device due to thermal expansion mismatch; and such a stress can result in degradation and/or failure of the mechanical seal and flexible plate during the manufacture and use of the device.

It is noted that sensitivity of a capacitive pressure sensor is related to the gap between the two parallel plates. Generally, a smaller gap provides an improved sensitivity.

In some implementations, the present disclosure relates to capacitive pressure sensors having a very small gap with dimensions that are controllable during fabrication. In some embodiments, such capacitive pressure sensors can include high temperature co-fired ceramic (HTCC) material for improved thermal and mechanical properties compared to capacitive pressure sensors having LTCC material.

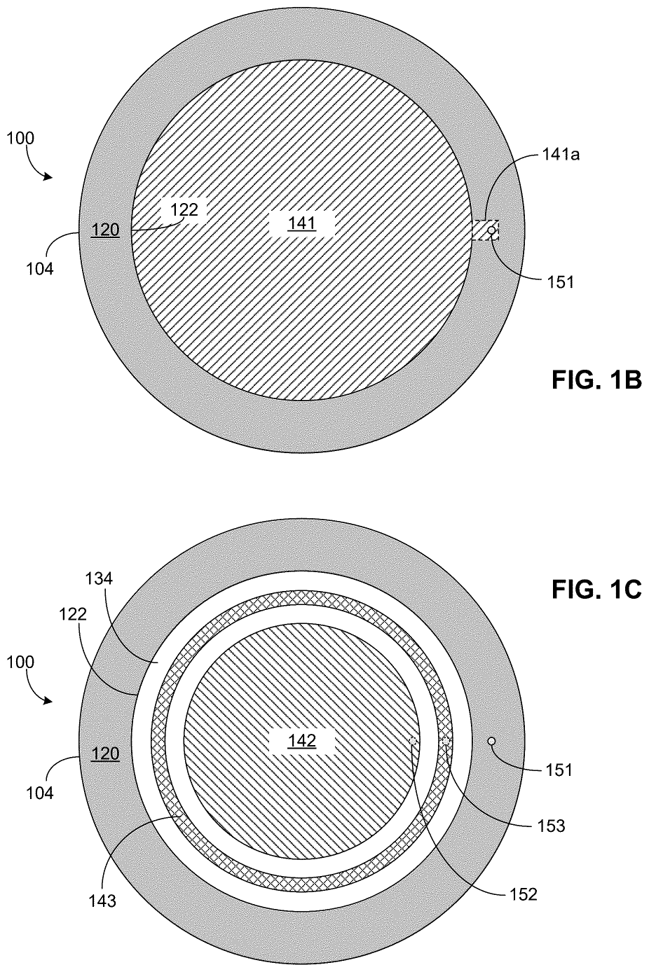

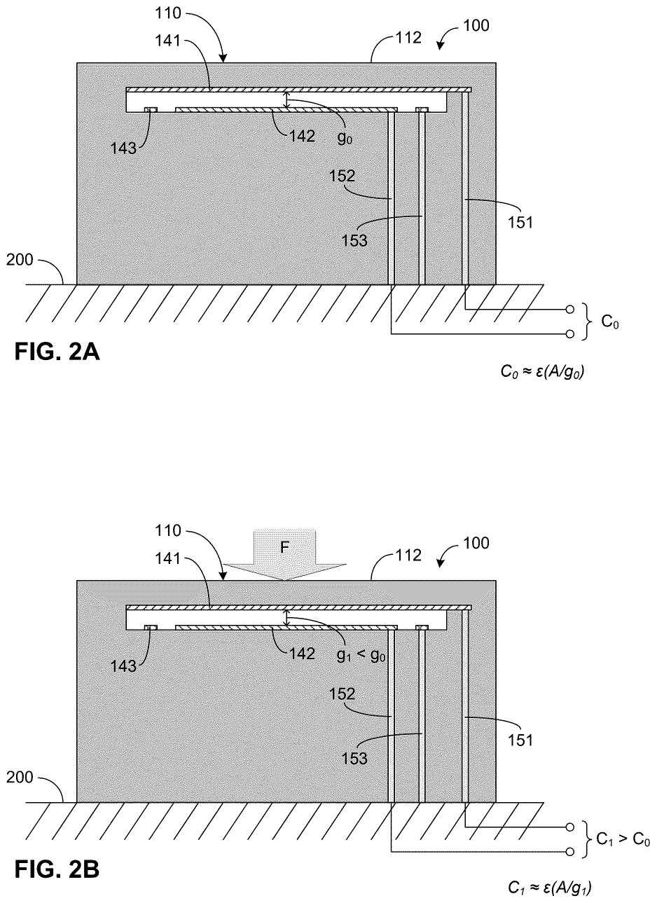

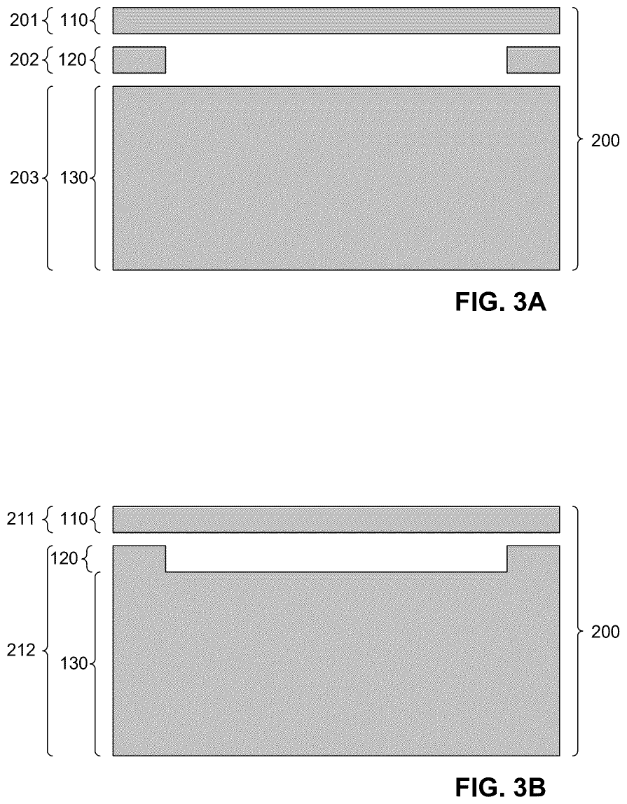

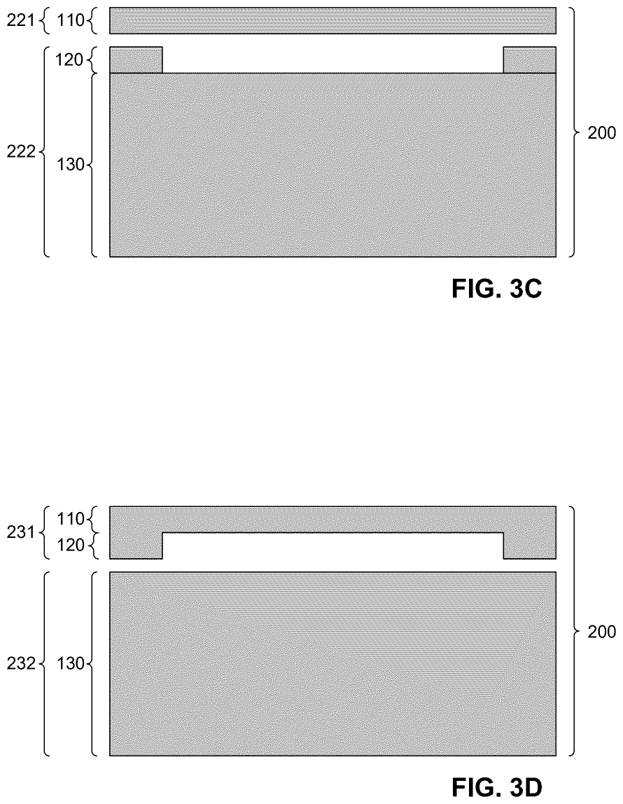

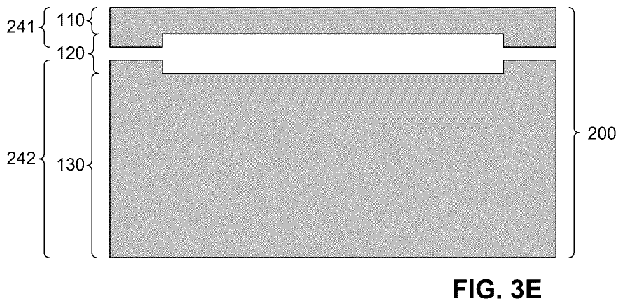

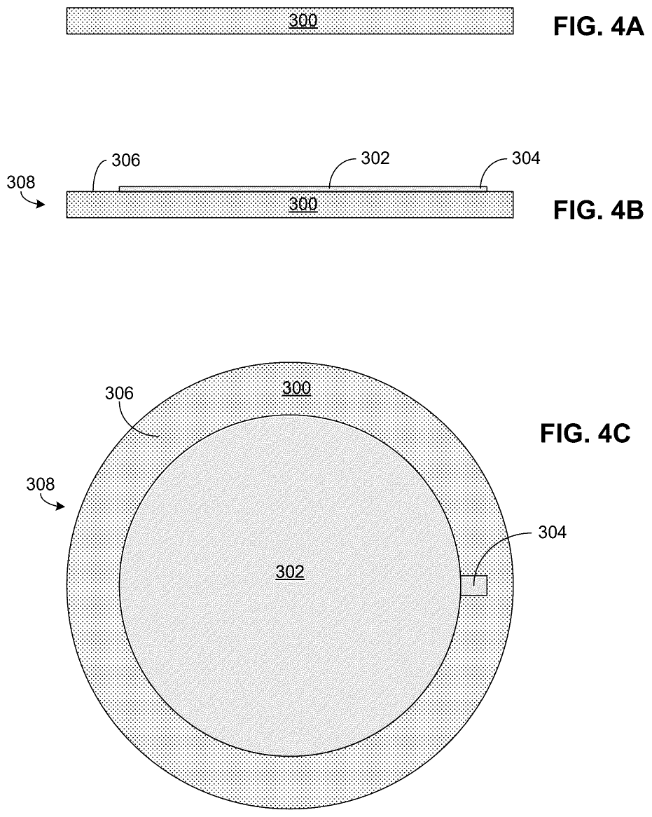

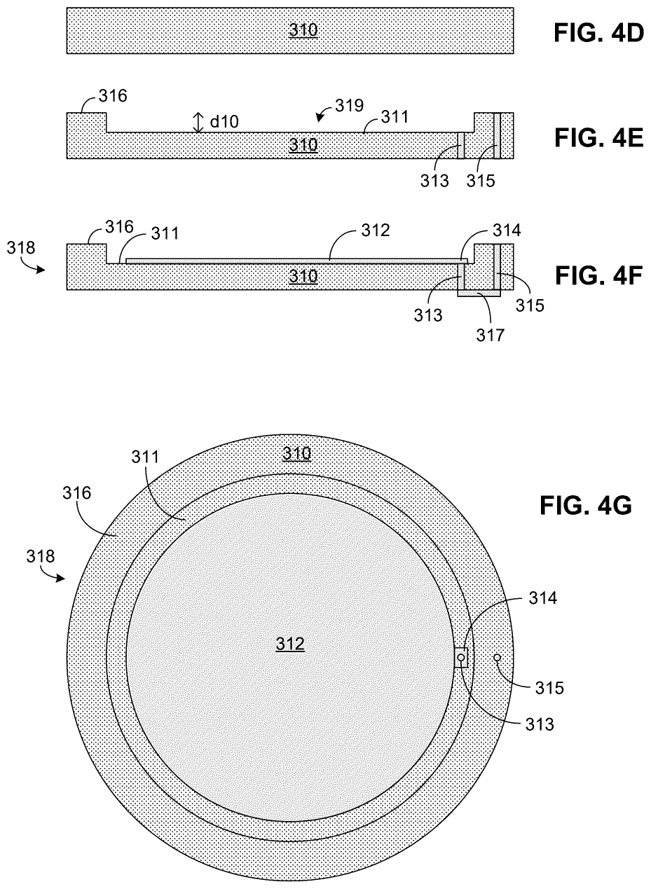

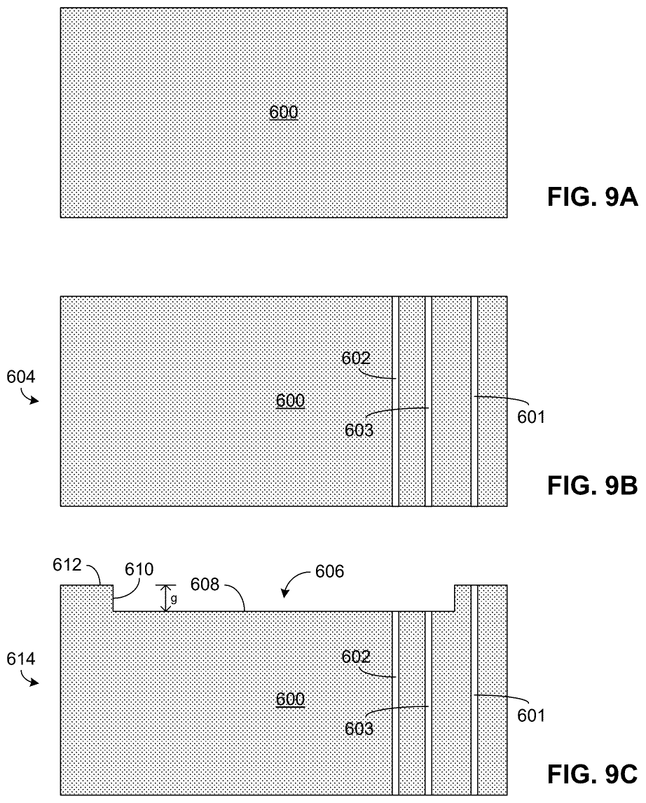

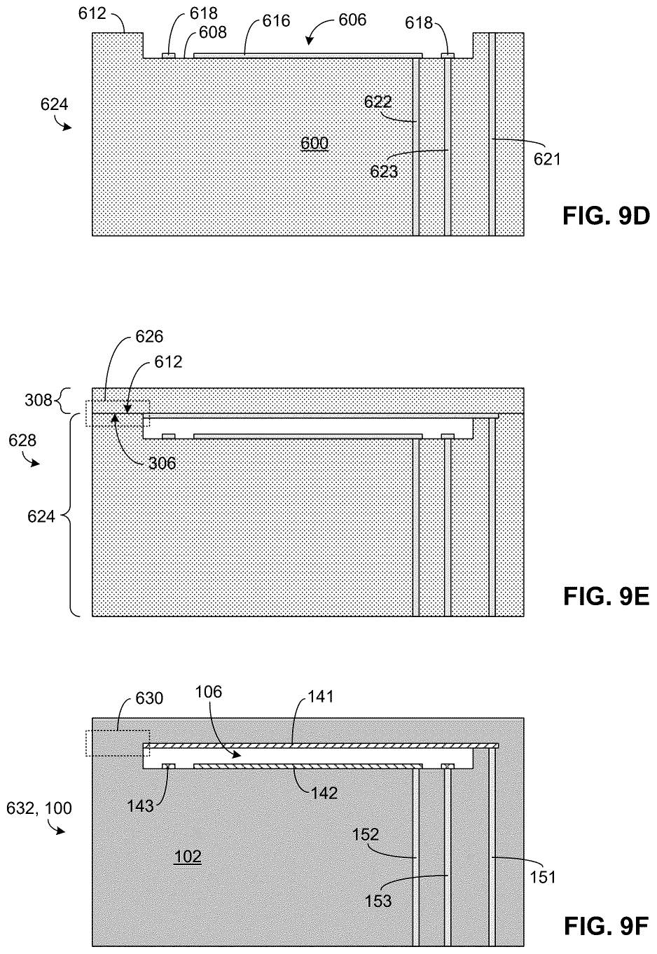

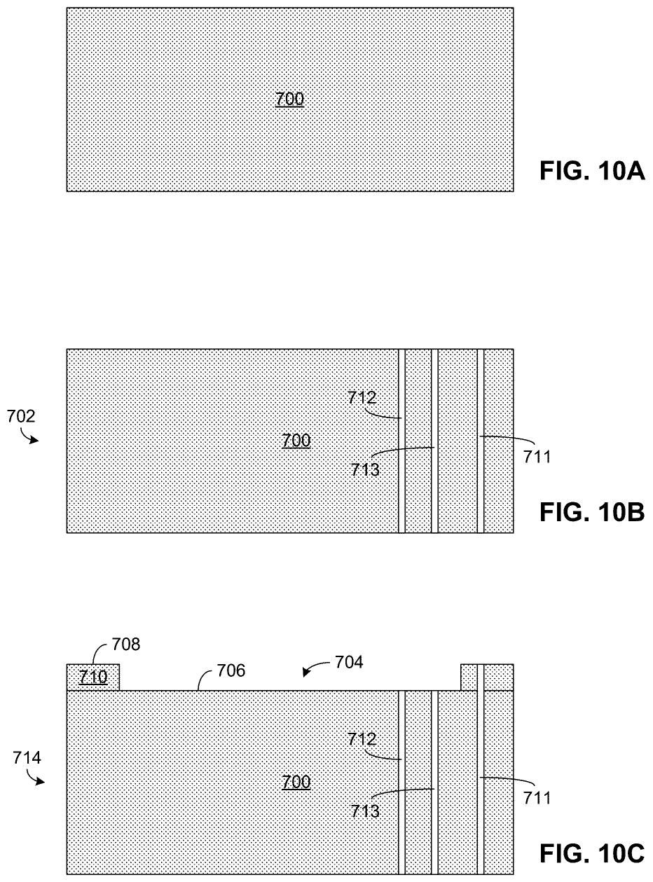

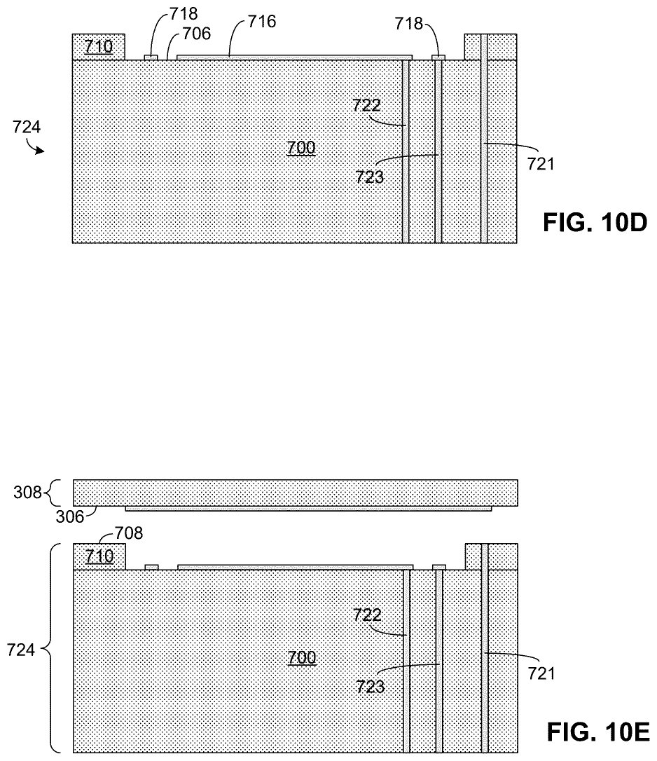

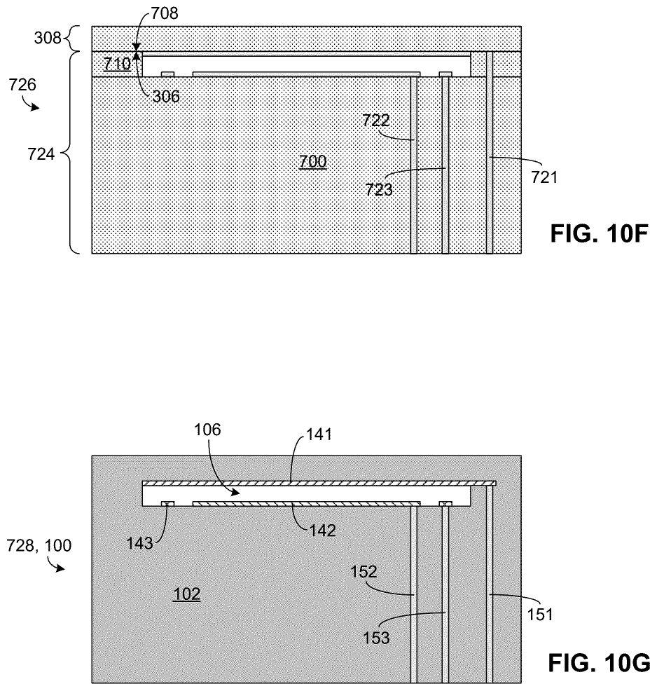

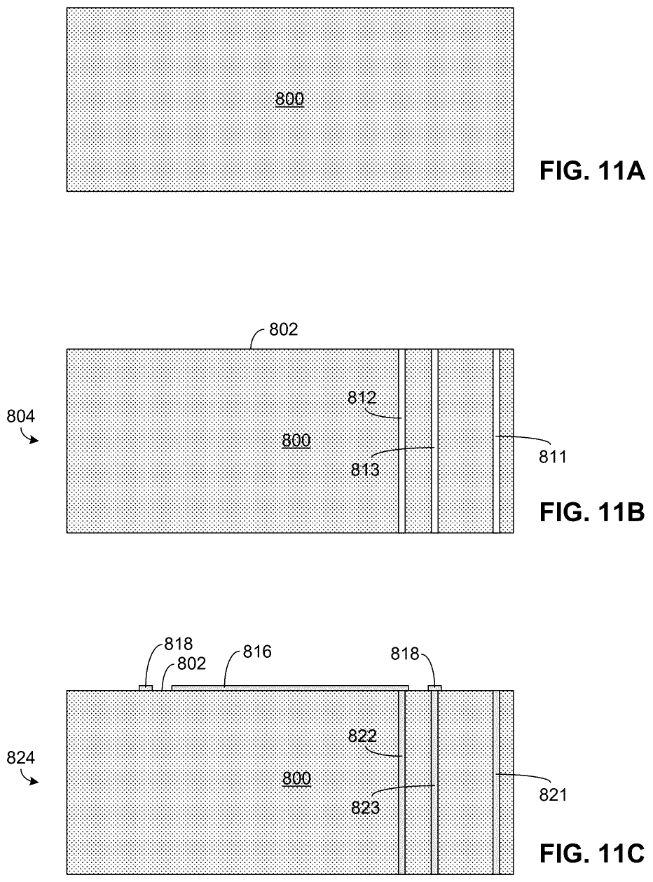

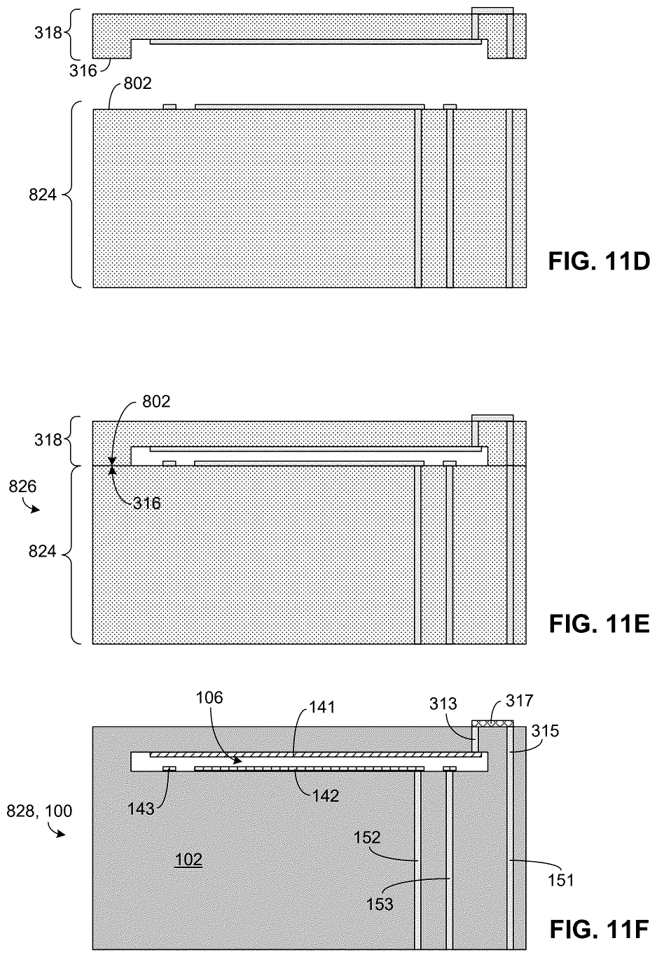

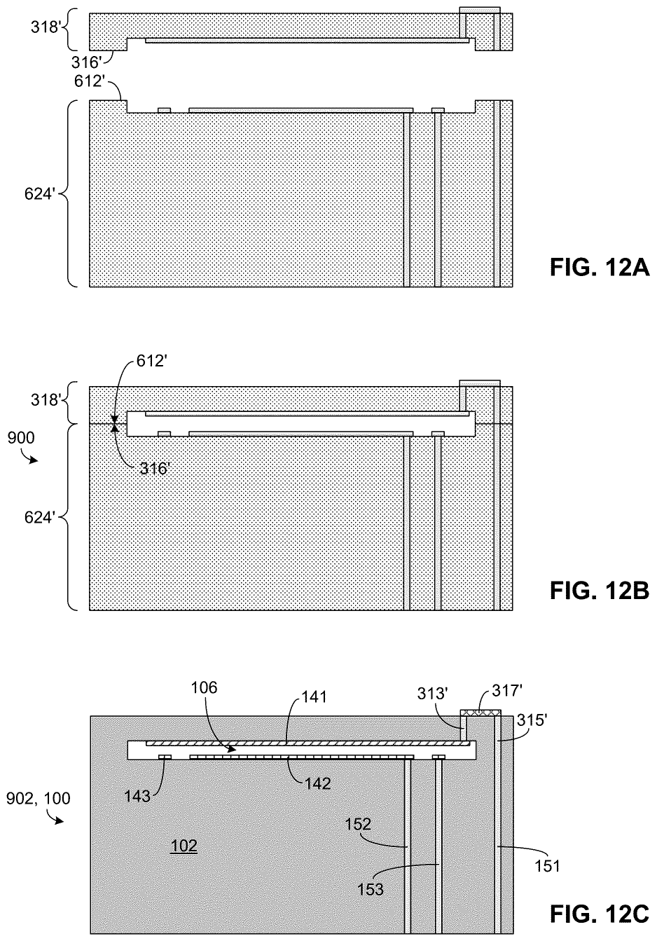

A number of examples of capacitive pressure sensors having the foregoing properties are described herein. FIG. 3A shows a first example of a capacitive pressure sensor, and FIGS. 4A to 4C and 5 to 7 show examples of how such a pressure sensor can be fabricated. FIG. 3B shows a second example of a capacitive pressure sensor, and FIGS. 4A to 4C and 9 show examples of how such a pressure sensor can be fabricated. FIG. 3C shows a third example of a capacitive pressure sensor, and FIGS. 4A to 4C and 10 show examples of how such a pressure sensor can be fabricated. FIG. 3D shows a fourth example of a capacitive pressure sensor, and FIGS. 4D to 4G and 11 show examples of how such a pressure sensor can be fabricated. FIG. 3E shows a fifth example of a capacitive pressure sensor, and FIGS. 4D to 4G and 12 show examples of how such a pressure sensor can be fabricated.

FIG. 3A shows that in some embodiments, the pressure sensor 100 of FIGS. 1A to 1C can be formed from three separate pre-fired alumina pieces. More particularly, an assembly 200 of pre-fired alumina pieces can include a first pre-fired alumina piece 201 configured to be a deformable portion 110, a second pre-fired alumina piece 202 configured to be a support portion 120, and a third pre-fired alumina piece 203 configured to be a base portion 130.

In the example of FIG. 3A, the second pre-fired alumina piece 202 may also be referred to herein as a pre-fired alumina washer. In some embodiments, such a pre-fired alumina washer can have a thickness selected to provide a desirable gap between parallel plates to be implemented on facing surfaces of the first pre-fired alumina piece 201 and the third pre-fired alumina piece 203.

FIG. 3B shows that in some embodiments, the pressure sensor 100 of FIGS. 1A to 1C can be formed from two separate pre-fired alumina pieces. More particularly, an assembly 200 of pre-fired alumina pieces can include a first pre-fired alumina piece 211 configured to be a deformable portion 110, and a second pre-fired alumina piece 212 configured to include a support portion 120 and a base portion 130.

FIG. 3B shows that in some embodiments, the support portion 120 of the second pre-fired alumina piece 212 can be formed by providing a recess having a depth, such that the perimeter of the recess provides the support portion 120. Such a depth of the recess can be selected to provide a desirable gap between parallel plates to be implemented on facing surfaces of the first pre-fired alumina piece 211 and the floor of the recess of the second pre-fired alumina piece 212.

FIG. 3C shows that in some embodiments, the pressure sensor 100 of FIGS. 1A to 1C can be formed from two pre-fired alumina pieces joined by an unfired alumina spacer. More particularly, an assembly 200 of alumina pieces can include a pre-fired alumina piece 221 configured to be a deformable portion 110, and an alumina assembly 222 configured to include a support portion 120 and a base portion 130.

Referring to FIG. 3C, in some embodiments, the support portion 120 of the alumina assembly 222 can be formed from an unfired alumina spacer screen printed on a pre-fired alumina piece that forms the base portion 130. It is noted that in some embodiments, some or all of unfired components can be made by various ceramic fabrication processes such as dry pressing, tape casting, roll compaction, etc. It is further noted that thick film screen printing can have benefits including control of thickness and ability to form thinner features.

FIG. 3C shows that in some embodiments, the support portion 120 formed from the unfired alumina spacer is shown to provide a recess having a depth. Thus, such a depth of the recess associated with the thickness of the unfired alumina spacer can be selected to provide a desirable gap between parallel plates to be implemented on facing surfaces of the pre-fired alumina piece 221 and the base portion 130 of the alumina assembly 200.

FIG. 3D shows that in some embodiments, the pressure sensor 100 of FIGS. 1A to 1C can be formed from two separate pre-fired alumina pieces. More particularly, an assembly 200 of pre-fired alumina pieces can include a first pre-fired alumina piece 231 configured to include a deformable portion 110 and a support portion 120, and a second pre-fired alumina piece 232 configured to include a base portion 130.

FIG. 3D shows that in some embodiments, the support portion 120 of the first pre-fired alumina piece 231 can be formed by providing a recess having a depth, such that the perimeter of the recess provides the support portion 120. Such a depth of the recess can be selected to provide a desirable gap between parallel plates to be implemented on facing surfaces of the floor of the recess of the first pre-fired alumina piece 231 and the second pre-fired alumina piece 232. It is noted that in some embodiments, the example of FIG. 3D can be implemented when a reduced thickness of the flexure membrane (deformable portion 110 of the first pre-fired alumina piece 231) is desired to increase the amount of deflection at a given pressure compared to a thicker membrane.

FIG. 3E shows that in some embodiments, the pressure sensor 100 of FIGS. 1A to 1C can be formed from two separate pre-fired alumina pieces. More particularly, an assembly 200 of pre-fired alumina pieces can include a first pre-fired alumina piece 241 configured to include a deformable portion 110 and a part of a support portion 120, and a second pre-fired alumina piece 242 configured to include a base portion 130 and another part of the support portion 120.

FIG. 3E shows that in some embodiments, the respective part of the support portion 120 of the first pre-fired alumina piece 241 can be formed by providing a first recess having a depth, such that the perimeter of the first recess provides the respective part of support portion 120. Similarly, the respective part of the support portion of the second pre-fired alumina piece 242 can be formed by providing a second recess having a depth, such that the perimeter of the second recess provides the respective part of support portion 120. In some embodiments, the depths of the first and second recesses can be selected to provide a desirable gap between parallel plates to be implemented on facing surfaces of the floor of the first recess of the first pre-fired alumina piece 241 and the floor of the second recess of the second pre-fired alumina piece 242.

FIGS. 4A to 4C and 4D to 4G show various stages of processes where first pre-fired alumina pieces (e.g., 201, 211, 221 of FIGS. 3A to 3C, and 231, 241 of FIGS. 3D and 3E) of capacitive pressure sensors can be fabricated. More particularly, the pre-fired alumina piece formed in the process of FIGS. 4A to 4C can be utilized as the deformable portion 110 in each of the three examples of FIGS. 3A to 3C; and the pre-fired alumina piece with a recess formed in the process of FIGS. 4D to 4G can be utilized as an assembly that includes a deformable portion and a support portion.

FIG. 4A shows a side view of a pre-fired alumina ceramic disk 300 having a thickness selected to allow the disk to deform when supported on its perimeter on one side and subjected to pressure. Examples of how such a pre-fired alumina ceramic disk can be formed, as well as use of other HTCC materials, are described herein in greater detail.

FIG. 4B shows a side view of an assembly 308 where an electrode 302 and an electrical coupling tab 304 are formed on a surface 306 of the pre-fired alumina ceramic disk 300. FIG. 4C shows a plan view of the assembly 308 of FIG. 4B. In some embodiments, the electrode 302 and the electrical coupling tab 304 can be formed by a screen printing process on the surface 306 of the pre-fired alumina ceramic disk 300, followed by a drying process.

FIG. 4D shows a side view of a pre-fired alumina ceramic disk 310 having a thickness selected to allow formation of a recess such that a deformable portion defined by the recess is supported by a perimeter of the recess. Examples of how such a pre-fired alumina ceramic disk can be formed, as well as use of other HTCC materials, are described herein in greater detail.

FIG. 4E shows a side view of a stage where a recess 319 is formed to provide a recess with a depth d10 from an upper surface 316 of the disk 310 and a floor 311 of the recess 319. In some embodiments, such a recess can be formed by, for example, a dry press process or laser machining. The resulting recess is shown to be defined by the floor 311 and a perimeter around the recess 319, with the perimeter having the surface 316 that will be utilized to mate with a surface of a pre-fired alumina ceramic part (e.g., 232 of FIG. 3D or 242 of FIG. 3D) that includes a base portion.

In the example of FIG. 4E, conductive vias 313, 315 are shown to be provided. More particularly, the conductive via 313 is shown to be provided from the floor 311 of the recess 311 to the other side of the disk 310, and the conductive via 315 is shown to be provided from the surface 316 of the perimeter to the other side of the disk 310. In some embodiments, such vias can be formed similar to any of the example processes described herein.

FIG. 4F shows an assembly 318 where an electrode 312 and an electrical coupling tab 314 are formed on the floor 311 of the recess 319 of the pre-fired alumina ceramic disk 310 of FIG. 4E. FIG. 4G shows a plan view of the assembly 318 of FIG. 4F. In some embodiments, the electrode 312 and the electrical coupling tab 314 can be formed by a screen printing process on the floor 311, followed by a drying process.

In the example of FIG. 4F, a conductive path 317 is shown to be formed on the side of the disk 310 opposite from the surface 316 and the recess 319. In some embodiments, such a conductive path can be formed by a process similar to the formation of the coupling tab 314, to thereby provide an electrical connection between the electrode 312 to the end of the conductive via 315 at the surface 316.

### EXAMPLE 1

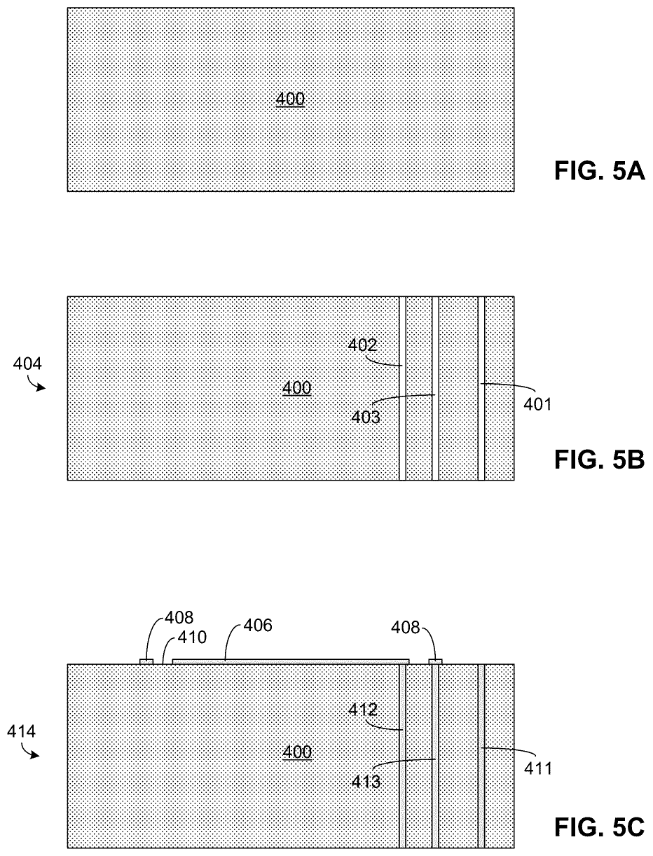

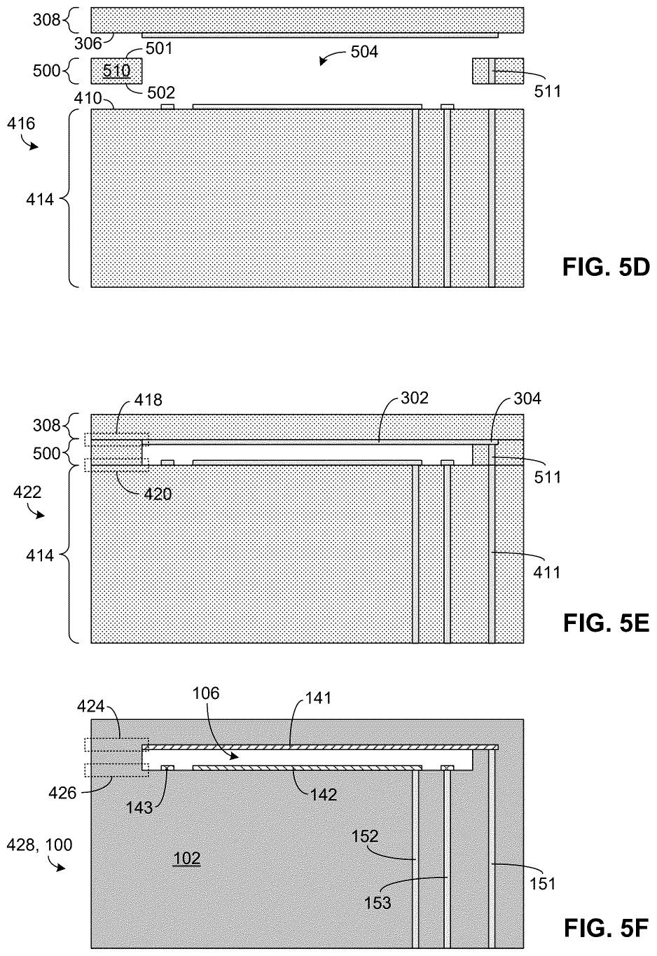

FIGS. 5 to 7 show various views and stages of a process where a base portion of a capacitive pressure sensor can be fabricated. Such a base portion can be, for example, the base portion 130 of FIG. 1A. In some embodiments, the base portion formed in the examples of FIGS. 5 to 7 can be utilized as the base portion 130 in the example of FIG. 3A.

FIG. 5A shows a side view of a pre-fired alumina ceramic base 400 having a thickness selected to provide a base functionality for a corresponding capacitive pressure sensor. Examples of how such a pre-fired alumina ceramic base can be formed, as well as use of other HTCC materials, are described herein in greater detail.

FIG. 5B shows a stage where through-vias 401, 402, 403 are formed so as to provide an assembly 404. In some embodiments, such vias can be formed by, for example, mechanical or laser drilling through the ceramic base 400. In some embodiments, a dry pressing process can be utilized to form the base 400, and such a process can include formation of the through-vias 401, 402, 403. In some embodiments, the base can be formed from tape cast and roll compacted green ceramic tapes, and via holes such as the vias 401, 402, 403 can be punched into such tapes prior to a firing process.

FIG. 5C shows a stage where the through-vias 401, 402, 403 of FIG. 5B are filled with conductive material so as to form respective conductive vias 411, 412, 413. In FIG. 5C, a base electrode 406 and a guard electrode 408 are shown to be formed on a surface 410 of the ceramic base 400, so as to form an assembly 414.

In the example of FIG. 5C, the conductive vias 411, 412, 413 can be formed by, for example, filling the via holes 401, 402, 403 by screen printing followed by vacuum to pull metal ink into hole and coat the surface of the via holes. High temperature metals such as platinum and tungsten can be utilized for such conductive vias to accommodate high temperatures involved in diffusion bonding/co-firing process.

In some embodiments, the base electrode 406 and the guard electrode 408 can be formed by a screen printing process on the surface 410 of the ceramic base 400, followed by a drying process. Accordingly, the conductive via 412 is shown to be electrically connected to the base electrode 406, the conductive via 413 is shown to be electrically connected to the guard electrode 408, and the conductive via 411 is configured to become electrically connected to an electrode of a deformable portion (e.g., 302 in FIGS. 4B and 4C, through the conductive tab 304) when the deformable portion is joined with a completed base portion.

In the example of FIG. 5C, it is noted that the guard electrode may or may not be utilized.

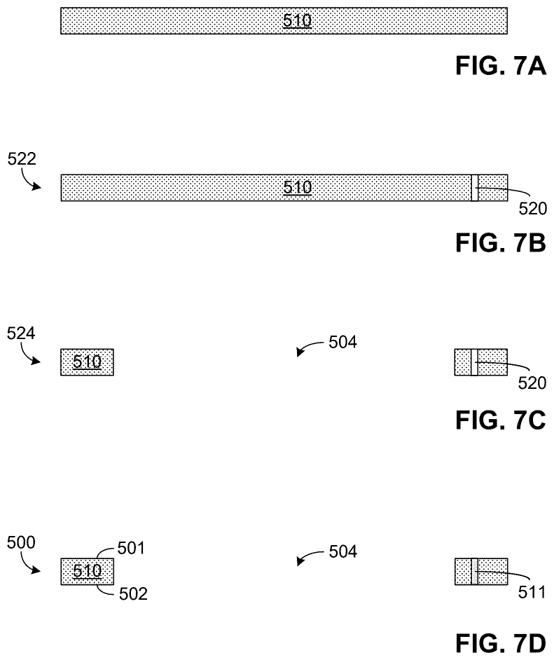

FIG. 5D shows a stage where the assembly 308 of FIGS. 4B and 4C and the assembly 414 of FIG. 5C are being assembled with a washer assembly 500 therebetween, so as to provide an assembly 416. FIGS. 7A to 7D show an example of how such a washer assembly (500) can be fabricated.

Referring to FIG. 5D, the assembly 308 is shown to include a surface 306 where the electrode (302 in FIGS. 4B and 4C) is provided, such that the perimeter portion of the surface 306 can engage with a first surface 501 of the washer assembly 500. Similarly, the assembly 414 is shown to include a surface 410 where the electrodes (406, 408 in FIG. 5C) are provided, such that the perimeter portion of the surface 410 can engage with a second surface 502 of the washer assembly 500.

In some embodiments, at least the engaging portions of the surface 306 of the assembly 308, first and second surfaces 501, 502 of the washer assembly 500, and the surface 410 of the assembly 414 can be configured to allow co-firing at high temperatures.

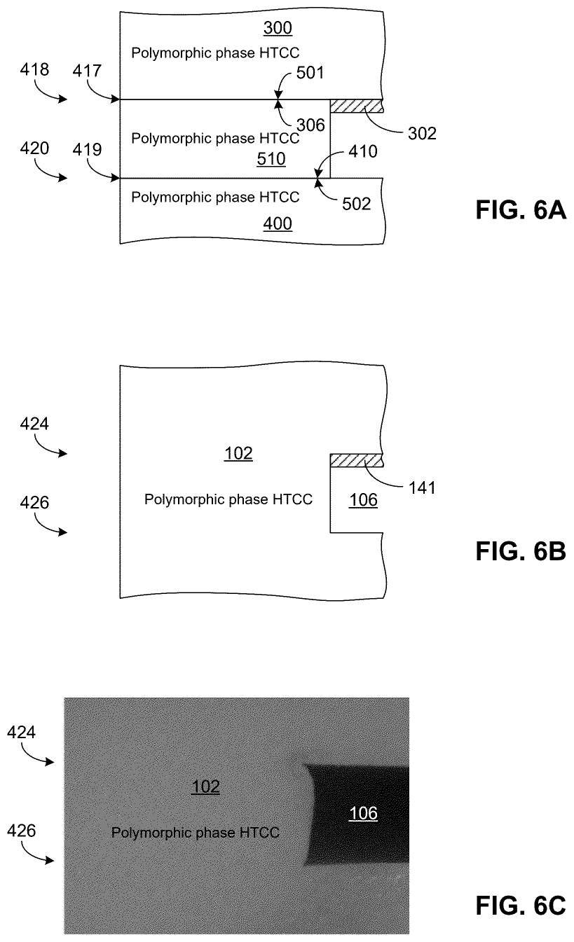

FIG. 5E shows a stage where the assemblies 308, 500 and 414 of FIG. 5D are in engagement, so as to provide an assembly 422. More particularly, the first surface (501 in FIG. 5D) of the washer assembly 500 is shown to be in engagement with the surface 306 of the assembly 308 to provide a first interface region 418, and the second surface 502 of the washer assembly 500 is shown to be in engagement with the surface 410 of the assembly 414 to provide a second interface region 420. FIG. 6A shows an enlarged view of the interface regions 418, 420.

Referring to FIG. 5E, it is noted that the electrode 302 of the assembly 308 is now electrically connected to the conductive via 411 of the assembly 414 through the conductive tab 304 of the assembly 308 and a conductive via 511 of the washer assembly 500.

FIG. 5F shows a stage where assemblies 308, 500 and 414 of FIG. 5E have been co-fired at high temperatures, so as to provide an assembly 428. Such an assembly (428) is similar to the capacitive pressure sensor 100 of FIG. 1A; thus, the assembly 428 in FIG. 5F is also indicated as 100.

In FIG. 5F, regions that were previously first and second interface regions 418, 420 in FIG. 5E are indicated as bonded or co-fired regions 424, 426, respectively. FIG. 6B shows an enlarged view of the bonded or co-fired regions 424, 426.

Referring to FIGS. 5A to 5F, 6A and 6B, it is noted that HTCC processing allows a resulting capacitive pressure sensor to be operated at higher temperatures than LTCC devices (e.g., ~1000° C. vs ~600° C.). Such an HTCC pressure sensor also eliminates or significantly reduces stress due to thermal expansion mismatch between materials during fabrication by making the ceramic parts of the sensor out of alumina ceramic having polymorphic phase property. In some embodiments, 96% alumina ceramic material can be utilized for the ceramic parts. It will be noted that in some embodiments, ceramic parts of an HTCC pressure sensor can include other ceramic materials having polymorphic phase property.

In some embodiments, ceramic parts of an HTCC pressure sensor can be formed from other ceramic materials with suitable mechanical and electrical properties including, but not limited to, zirconia, aluminum nitride, silicon nitride, beryllia, and zirconia toughened alumina (ZTA).

In some embodiments, ceramic components for an HTCC pressure sensor can be formed using ceramic processing methods such as dry pressing, roll compaction, or tape casting followed by high temperature firing to produce a dense gas impermeable ceramic with desired mechanical strength and electrical resistance properties.

In some embodiments, conductive and dielectric electrodes can be screen printed to respective alumina parts and be dried.

As described herein, joining of the ceramic parts of an HTCC pressure sensor can be accomplished by co-firing at high temperatures. Such a high temperature bonding process produces a device that can be operated at 1000° C. in reducing or oxidizing atmospheres.

Referring to the enlarged view of FIG. 6A, it is noted that in the first and second interface regions 418, 420, the respective mating surfaces (306 and 501 for the first interface region 418, and 410 and 502 for the second interface region 420) are configured to allow co-firing boundaries 417, 419. Upon completion of such co-firing, and as shown in FIG. 6B, such first and second co-firing boundaries (417, 419) are no longer discernible in respective bonded regions 424, 426, and the resulting ceramic structure 102 is essentially a single piece.

FIG. 6C shows a photograph of a sectional view of a ceramic structure 102 of an actual HTCC pressure sensor fabricated according to the example of FIGS. 4 to 7. Such an HTCC pressure sensor was produced as follows.

An HTCC capacitive pressure sensing device that includes a 0.040″ thick bottom alumina plate (400 in FIG. 5A), an alumina spacer washer (0.010-0.015″ thick) (510 in FIG. 7A), and an alumina flexure plate (0.010-0.015″ thick) (300 in FIG. 4A) was fabricated. Spacer washers and flexure plates were made by laser cutting 96% alumina substrates with a thickness of ~0.010-0.015″. A 0.040″ thick 96% alumina substrate was laser cut into bottom alumina plates.

All of the foregoing alumina components were pre-fired to >98% dense. A conductive electrode was screen printed and dried onto the flexure and base plates, and a dielectric layer was printed on top of the base plate conductive electrode to prevent a possible short circuit of the sensor at high pressures.

The three pre-fired alumina components were then stacked and co-fired at 1600° C. for 4 hours with a weight placed on top of the stack to promote bonding.

In the photograph of FIG. 6C, the fracture cross-section of the resulting HTCC pressure sensing device shows excellent bonding in the bonded regions 424, 426, where bonding boundaries are not discernible.

FIGS. 7A to 7D show various stages of a process where a washer assembly can be fabricated. As described herein, such a washer assembly can also be referred to as washer, a spacer or a washer spacer. Such a washer spacer is described as being utilized in the example of FIG. 5D.

FIG. 7A shows a side view of a pre-fired alumina ceramic spacer 510 having a thickness selected to provide assembly and capacitance gap functionalities for a corresponding capacitive pressure sensor. Examples of how such a pre-fired alumina ceramic spacer can be formed, as well as use of other HTCC materials, are described herein in greater detail.

FIG. 7B shows a stage where a through-via 520 is formed so as to provide an assembly 522. In some embodiments, such vias can be formed by, for example, mechanical or laser drilling through the ceramic spacer 510. As described herein, vias can be formed by a green forming process including dry pressing. Also, tape casting and roll compaction processes can be utilized to produce a flexible green ceramic film or tape that can have vias punched into it, followed by high temperature firing to produce a dense ceramic with via holes. It is noted that a green ceramic refers to a ceramic part prior to firing or sintering. A green ceramic part typically has binders and plasticizers added to powder to enable the powder to be formed into various shapes and provide enough mechanical strength to handle and process (e.g., via punch process).

FIG. 7C shows a stage where an aperture 504 is formed through the ceramic spacer 510, so as to provide an assembly 524. In some embodiments, such an aperture can be formed by, for example, a mechanical punch-through operation or a laser cutting operation.

FIG. 7D shows a stage where the through-via 520 of FIG. 7C is filled with conductive material so as to form a conductive via 511, so as to provide an assembly 500. In some embodiments, such a conductive via can be formed by, for example, a screen printing operation. It is noted that the assembly 500 is similar to the assembly 500 of FIG. 5D, and thus can be utilized to provide the assembly and capacitance gap functionalities for a corresponding capacitive pressure sensor.

In some embodiments, a washer spacer assembly fabricated in the foregoing manner can be provided with a selected thickness to control the gap between two electrodes of the corresponding capacitive pressure sensor. As described herein, such a gap between electrodes can vary depending on the amount of pressure being applied to the deformable or flexure assembly (308 in FIGS. 4B and 4C) thereby allowing measurement of capacitance value of C≈ε(A/g).

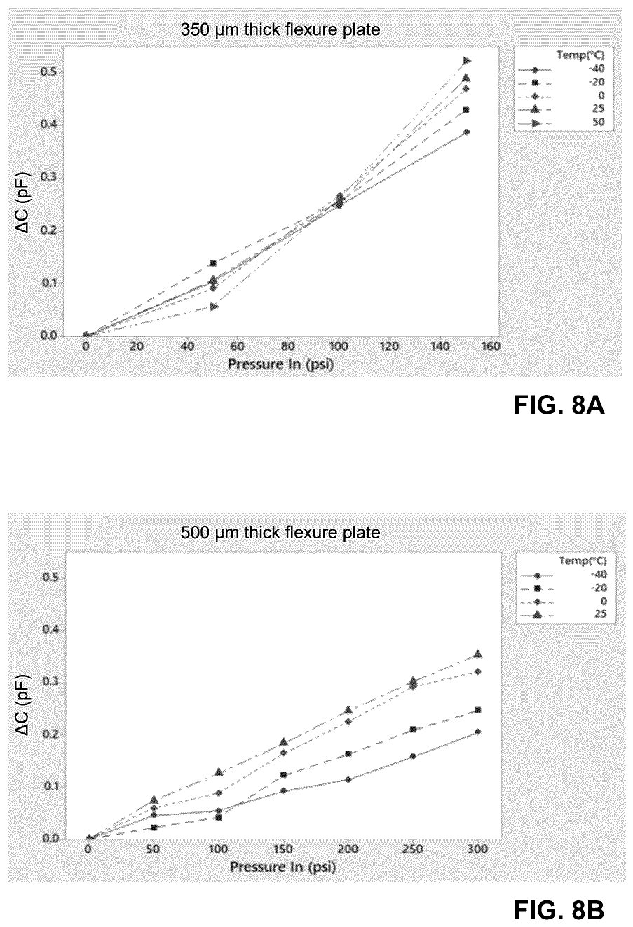

In some embodiments, the amount of deformation of flexing of the flexure assembly (308 in FIGS. 4B and 4C), and thus the corresponding change in capacitance (where the un-flexed configuration at no applied pressure is assumed to have no change in capacitance), can depend on design parameters such as lateral dimension and thickness of the flexure assembly. For example, FIGS. 8A and 8B show capacitance-change (ΔC) as a function of applied pressure for two capacitive pressure sensors produced according to the examples of FIGS. 5 to 7, where flexure plates have thicknesses 350 μm and 500 μm, respectively. One can see that since the thicker flexure plate (500 μm) flexes less, the change in gap dimension (g), and thus the capacitance-change (AC), is less than the other flexure plate (350 μm).

### EXAMPLE 2

FIGS. 9A to 9F show various stages of a process where a pre-fired alumina piece of a capacitive pressure sensor can be fabricated. Such an alumina piece can provide, for example, the base and support portions 130, 120 of FIG. 1A. In some embodiments, the alumina piece formed in the examples of FIGS. 9A to 9F can be utilized as the second pre-fired alumina piece 212 in the example of FIG. 3B.

FIG. 9A shows a side view of a pre-fired alumina ceramic base 600 having a thickness selected to provide a base functionality for a corresponding capacitive pressure sensor. Examples of how such a pre-fired alumina ceramic base can be formed, as well as use of other HTCC materials, are described herein in greater detail.

FIG. 9B shows a stage where through-vias 601, 602, 603 are formed so as to provide an assembly 604. In some embodiments, such vias can be formed by, for example, mechanical or laser drilling through the ceramic base 600.

FIG. 9C shows a stage where a recess 606 is formed on one side of the ceramic base 600, so as to provide an assembly 614. In some embodiments, such a recess can be formed by, for example, a dry press process or laser machining. The resulting recess is shown to be defined by a floor 608 at a selected depth g and a recess-wall 610. The perimeter around the recess 606 is shown to include a surface 612 that will be utilized to mate with the surface 306 of the assembly 308 of FIGS. 4B and 4C.

It is noted that the technique associated with FIG. 9C eliminates one component and one bond interface when compared to the first example of FIGS. 5 to 7. Thus, in some implementations, fabrication of HTCC pressure sensors can be simplified, and related costs can be reduced, while providing excellent control of gap thickness based on control of recess depth.

FIG. 9D shows a stage where the through-vias 601, 602, 603 of FIG. 9C are filled with conductive material so as to form respective conductive vias 611, 612, 613. In FIG. 9D, a base electrode 616 and a guard electrode 618 are shown to be formed on the surface 608 of the recess 606, so as to form an assembly 624.

In some embodiments, the base electrode 616 and the guard electrode 618 can be formed by a screen printing process on the floor 608 of the recess 606, followed by a drying process. Accordingly, the conductive via 622 is shown to be electrically connected to the base electrode 616, the conductive via 623 is shown to be electrically connected to the guard electrode 618, and the conductive via 621 is configured to become electrically connected to an electrode of a deformable portion (e.g., 302 in FIGS. 4B and 4C, through the conductive tab 304) when the deformable portion is joined with a completed base portion.

In the example of FIG. 9D it is noted that the guard electrode may or may not be utilized.

FIG. 9E shows a stage where the assembly 624 of FIG. 9D is assembled with the assembly 308 of FIGS. 4B and 4C, so as to provide an assembly 628.

Referring to FIG. 9E, the assembly 308 is shown to include a surface 306 where the electrode (302 in FIGS. 4B and 4C) is provided, such that the perimeter portion of the surface 306 can engage with the surface 612 of the assembly 624. In some embodiments, at least the engaging portions of the surface 306 of the assembly 308 and the surface 612 of the assembly 624 can be configured to allow co-firing at high temperatures.

Referring to FIG. 9E, the surface 612 of the base assembly 624 is shown to be in engagement with the surface 306 of the assembly 308 to provide an interface region 626.

Referring to FIG. 9E, it is noted that the electrode 304 of the assembly 308 is now electrically connected to the conductive via 621 of the assembly 624 through the conductive tab 304 of the assembly 308.

FIG. 9F shows a stage where assemblies 308 and 624 of FIG. 9E have been co-fired at high temperatures, so as to provide an assembly 632. Such an assembly (632) is similar to the capacitive pressure sensor 100 of FIG. 1A; thus, the assembly 632 in FIG. 9F is also indicated as 100.

In FIG. 9F, region that was previously interface regions 626 in FIG. 9E is indicated as bonded or co-fired region 630. The bonded or co-fired region 630 can be similar to the bonded or co-fired regions described herein in reference to FIGS. 5 and 6. More particularly, the co-firing at high temperatures can result in the co-fired region 630 having no discernible bonding boundary (e.g., defined by the mating surfaces 306 and 612 in FIG. 9E), such that the resulting ceramic structure 102 is essentially a single piece.

### EXAMPLE 3

FIGS. 10A to 10G show various stages of a process where a capacitive pressure sensor can be fabricated utilizing a pre-fired alumina ceramic base and a thick film spacer. Such an alumina base and thick film spacer can provide, for example, the base and support portions 130, 120 of FIG. 1A. In some embodiments, the alumina base and thick film spacer formed in the examples of FIGS. 10A to 10G can be utilized as the second pre-fired alumina piece 222 in the example of FIG. 3C.

FIG. 10A shows a side view of a pre-fired alumina ceramic base 700 having a thickness selected to provide a base functionality for a corresponding capacitive pressure sensor. Examples of how such a pre-fired alumina ceramic base can be formed, as well as use of other HTCC materials, are described herein in greater detail.

FIG. 10B shows a stage where through-vias 711, 712, 713 are formed so as to provide an assembly 702. In some embodiments, such vias can be formed by, for example, mechanical or laser drilling through the ceramic base 700.

FIG. 10C shows a stage where a recess 704 is formed on one side of the ceramic base 700, so as to provide an assembly 714. In some embodiments, such a recess can be formed by, for example, a thick film 710 screen printed along the perimeter of a surface 706 of the ceramic base 700. The resulting recess is shown to be defined by the surface 706 as a floor at a selected depth. The thick film 710 is shown to include a surface 708 that will be utilized to mate with the surface 306 of the assembly 308 of FIGS. 4B and 4C. In some embodiments, in addition to or in place of a thick film screen print, a green ceramic washer formed by dry pressing, tape casting, roll compaction, etc., can be utilized to form the support layer 710 for providing a gap with a desired thickness.

In the example of FIG. 10C, the screen printing of the thick film 710 can include formation of a through-via that aligns with the through-via 711 of the ceramic base 700.

In some embodiments, the thick film 710 can be formed from unfired alumina material. In some embodiments, such alumina material can be printed on either or both of the components (e.g., top plate and base plate) depending on the gap that is desired.

FIG. 10D shows a stage where the through-vias 711, 712, 713 of FIG. 10C are filled with conductive material so as to form respective conductive vias 721, 722, 723. In FIG. 10D, a base electrode 716 and a guard electrode 718 are shown to be formed on the surface 706 of the recess 704, so as to form an assembly 724.

In some embodiments, the base electrode 716 and the guard electrode 718 can be formed by a screen printing process on the floor 706 of the recess 704, followed by a drying process. Accordingly, the conductive via 722 is shown to be electrically connected to the base electrode 716, the conductive via 723 is shown to be electrically connected to the guard electrode 718, and the conductive via 721 is configured to become electrically connected to an electrode of a deformable portion (e.g., 302 in FIGS. 4B and 4C, through the conductive tab 304) when the deformable portion is joined with a completed base portion.

In the example of FIG. 10D it is noted that the guard electrode may or may not be utilized.

FIG. 10E shows a stage where the assembly 724 of FIG. 10D is to be assembled with the assembly 308 of FIGS. 4B and 4C. The assembly 308 is shown to include a surface 306 where the electrode (302 in FIGS. 4B and 4C) is provided, such that the perimeter portion of the surface 306 can engage with the surface 708 of the assembly 724. In some embodiments, at least the engaging portions of the surface 306 of the assembly 308 and the surface 708 of the assembly 724 can be configured to allow co-firing at high temperatures.

FIG. 10F shows a stage where the surface 708 of the base assembly 724 is shown to be in engagement with the surface 306 of the assembly 308 to provide an assembly 726.

Referring to FIG. 10F, it is noted that the electrode 304 of the assembly 308 is now electrically connected to the conductive via 721 of the assembly 724 through the conductive tab 304 of the assembly 308.

FIG. 10G shows a stage where assemblies 308 and 724 of FIG. 10E have been co-fired at high temperatures, so as to provide an assembly 728. Such an assembly (728) is similar to the capacitive pressure sensor 100 of FIG. 1A; thus, the assembly 728 in FIG. 10G is also indicated as 100.

In FIG. 10G, bonded or co-fired region between the surface 306 of the assembly 308 and the surface 708 of the thick film 710 can be similar to the co-fired regions described herein in reference to FIGS. 5 and 6. More particularly, the co-firing at high temperatures can result in the co-fired region having no discernible bonding boundary (e.g., defined by the mating surfaces 306 and 708 in FIG. 10F), such that the resulting ceramic structure 102 is essentially a single piece.

### EXAMPLE 4

FIGS. 11A to 11F show various stages of a process where a capacitive pressure sensor having a configuration similar to the example of FIG. 3D can be fabricated.

FIG. 11A shows a side view of a pre-fired alumina ceramic base 800 having a thickness selected to provide a base functionality for a corresponding capacitive pressure sensor. Examples of how such a pre-fired alumina ceramic base can be formed, as well as use of other HTCC materials, are described herein in greater detail.

FIG. 11B shows a stage where through-vias 811, 812, 813 are formed from a surface 802 to a surface of the other side, so as to provide an assembly 804. In some embodiments, such vias can be formed by, for example, mechanical or laser drilling through the ceramic base 800. In some embodiments, a dry pressing process can be utilized to form the base 800, and such a process can include formation of the through-vias 811, 812, 813. In some embodiments, the base can be formed from tape cast and roll compacted green ceramic tapes, and via holes such as the vias 811, 812, 813 can be punched into such tapes prior to a firing process.

FIG. 11C shows a stage where the through-vias 811, 812, 813 of FIG. 11B are filled with conductive material so as to form respective conductive vias 821, 822, 823. In FIG. 11C, a base electrode 816 and a guard electrode 818 are shown to be formed on the surface 802 of the ceramic base 800, so as to form an assembly 824.

In the example of FIG. 11C, the conductive vias 821, 822, 823 can be formed by, for example, filling the via holes 811, 812, 813 by screen printing followed by vacuum to pull metal ink into hole and coat the surface of the via holes. High temperature metals such as platinum and tungsten can be utilized for such conductive vias to accommodate high temperatures involved in diffusion bonding/co-firing process.

In some embodiments, the base electrode 816 and the guard electrode 818 can be formed by a screen printing process on the surface 802 of the ceramic base 800, followed by a drying process. Accordingly, the conductive via 822 is shown to be electrically connected to the base electrode 816, the conductive via 823 is shown to be electrically connected to the guard electrode 818, and the conductive via 821 is configured to become electrically connected to an electrode of a deformable portion (e.g., 312 in FIGS. 4F and 4G) when the respective assembly (318 in FIGS. 4F and 4G) is joined with a completed base portion.

In the example of FIG. 11C, it is noted that the guard electrode may or may not be utilized.

FIG. 11D shows a stage where the assembly 318 of FIGS. 4F and 4G and the assembly 824 of FIG. 11C are being assembled. In such a stage, the assembly 318 is shown to include a surface 316 for engaging with the surface 802 of the assembly 824.

FIG. 11E shows a stage where the assemblies 318 and 824 of FIG. 11D are in engagement, so as to provide an assembly 826. More particularly, the surface 316 of the assembly 318 is shown to be in engagement with the surface 802 of the assembly 802 to provide an interface region.

Referring to FIG. 11E, it is noted that the electrode (312 in FIGS. 4F and 4G) of the assembly 318 is now electrically connected to the conductive via 821 of the assembly 824 through the conductive features described herein in reference to FIGS. 4F and 4G.

FIG. 11F shows a stage where the assemblies 318 and 824 of FIG. 11E have been co-fired at high temperatures, so as to provide an assembly 828. Such an assembly (828) is similar to the capacitive pressure sensor 100 of FIG. 1A; thus, the assembly 828 in FIG. 11F is also indicated as 100.

### EXAMPLE 5

FIGS. 12A to 12C show various stages of a process where a capacitive pressure sensor having a configuration similar to the example of FIG. 3E can be fabricated.

FIG. 12A shows a stage where an assembly 318′ similar to the example of FIGS. 4F and 4G and an assembly 624′ similar to the example of FIG. 9D can be assembled. In such a stage, the assembly 318′ is shown to include a surface 316′ for engaging with a surface 612′ of the assembly 624′.

It is noted that the assembly 318′ of FIG. 12A may or may not be the same as the assembly 318 of FIG. 11D. Similarly, the assembly 624′ of FIG. 12A may or may not be the same as the assembly 624 of FIG. 9D. In some embodiments, the depth of the recess of each of the assemblies 318′ and 324′ can be selected to provide a desired flexing property of the assembly 318′ and/or a desired gap between the facing electrodes of the assemblies 318′ and 324′.

FIG. 12B shows a stage where the assemblies 318′ and 624′ of FIG. 12A are in engagement, so as to provide an assembly 900. More particularly, the surface 316′ of the assembly 318′ is shown to be in engagement with the surface 612′ of the assembly 624′ to provide an interface region.

FIG. 12C shows a stage where the assemblies 318′ and 624′ of FIG. 12B have been co-fired at high temperatures, so as to provide an assembly 902. Such an assembly (902) is similar to the capacitive pressure sensor 100 of FIG. 1A; thus, the assembly 902 in FIG. 12C is also indicated as 100.

It is noted that traditional HTCC devices typically involve screen printing of metal circuits and electrodes onto green ceramic components, laminating or green bonding them together, followed by high temperature co-firing of the green ceramic components to form a device. In various examples of HTCC devices described herein, manufacturing of such devices involves a different approach that includes utilizing pre-fired ceramic components (e.g., FIGS. 3A, 3B, 3D, 3E) rather than green (unfired) ceramic components. Unlike the traditional HTCC process, such a manufacturing process has involves firing of components then co-firing of the pre-fired components to form an HTCC device, thereby involving two high temperature cycles.

It is also noted that as described herein, “co-firing” of the foregoing pre-fired components at high temperature can result in a diffusion bond or diffusion bond-like joining of two pre-fired components. For the purpose of description, such a co-fired joining of two pre-fired components can include interdiffusion of elements between the two components being joined at high temperature.

It is further noted that the foregoing co-firing of pre-fired ceramic components at high temperature can include a number of benefits, including overcoming a challenge where co-firing of green ceramic components often results in deformation of some or all of the ceramic components during firing. Another challenge that can be overcome includes making of parts with internal channels and/or cavities that can be difficult due to likelihood of collapsing of the cavities. With co-firing of pre-fired components, however, formation of internal channels and/or cavities can be much less challenging.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A pressure sensor comprising:
a base formed from high-temperature co-fired ceramic (HTCC) material and including an inner surface;
a flexure plate formed from HTCC material and positioned over the surface of the base, the flexure plate including an inner surface that faces the surface of the base and an outer surface;
a spacer having a thickness and implemented between the base and the flexure plate to define a space between the inner surfaces of the base and flexure plate; and
first and second electrodes implemented on the inner surfaces of the base and the flexure plate, respectively, to form a capacitor, such that flexing of the flexure plate due to pressure applied to the outer surface of the flexure plate results in a detectable change in capacitance of the capacitor.

2. The pressure sensor of claim 1, wherein the HTCC material of the base is same as the HTCC material of the flexure plate.

3. The pressure sensor of claim 2, wherein the HTCC material of the base and the flexure plate includes polymorphic phase HTCC material.

4. The pressure sensor of claim 3, wherein the polymorphic phase HTCC material includes alumina.

5. The pressure sensor of claim 4, wherein the polymorphic phase HTCC material includes at least 96% alumina.

6. The pressure sensor of claim 1, wherein the spacer is formed from HTCC material.

7. The pressure sensor of claim 6, wherein the base, the flexure plate and the spacer are formed from a plurality of pieces of pre-fired HTCC and joined together to provide no discernible joint interface(s).

8. The pressure sensor of claim 7, wherein the base, the flexure plate and the spacer are formed from separate respective pieces of pre-fired HTCC.

9. The pressure sensor of claim 7, wherein the base and the spacer are formed from a single piece of pre-fired HTCC, and the flexure plate is formed from another piece of pre-fired HTCC.

10. The pressure sensor of claim 7, wherein the base is formed from a single piece of pre-fired HTCC, and the flexure plate and the spacer are formed from another piece of pre-fired HTCC.

11. The pressure sensor of claim 7, wherein the base and a first portion of the spacer are formed from a single piece of pre-fired HTCC, and the flexure plate and a second portion of the spacer are formed from another piece of pre-fired HTCC.

12. The pressure sensor of claim 7, wherein the plurality of pieces of HTCC are joined by co-firing of the plurality of pieces of HTCC.

13. The pressure sensor of claim 12, wherein the co-fired joint between the plurality of pieces of HTCC includes interdiffusion of elements between the HTCC pieces joined together.

14. The pressure sensor of claim 1, wherein the spacer is formed from an unfired HTCC on the inner surface of the base.

15. The pressure sensor of claim 14, wherein the base and the flexure plate are formed respective pieces of pre-fired HTCC.

16. The pressure sensor of claim 15, wherein the base, the flexure plate and the spacer are joined by co-firing.

17. A method for manufacturing a pressure sensor, the method comprising:
forming or providing a base assembly including pre-fired ceramic material and an inner surface;
forming a first electrode on the inner surface of the base assembly;
forming or providing a flexure assembly including pre-fired ceramic material, an inner surface and an outer surface;
forming a second electrode on the inner surface of the flexure assembly; and
co-firing the flexure assembly with the base assembly to provide a spacer having a thickness to define a space between the inner surfaces of the base assembly and the flexure assembly, and such that the first and second electrodes form a capacitor, such that flexing of the flexure assembly due to pressure applied to the outer surface of the flexure assembly results in a detectable change in capacitance of the capacitor.

18. (canceled)

19. The method of claim 17, wherein the pre-fired ceramic material of the base assembly is same as the pre-fired ceramic material of the flexure assembly.

20. The method of claim 19, wherein the pre-fired ceramic material of the base assembly and the flexure assembly includes polymorphic phase high-temperature co-fired ceramic (HTCC) material.

21. The method of claim 20, wherein the polymorphic phase HTCC material includes alumina.

22. (canceled)

23. (canceled)

24. (canceled)

25. (canceled)

26. (canceled)

27. (canceled)

28. (canceled)
